(19) United States
(12) Patent Application Publication
(10) Pub. No.: US 2022/0408695 A1
(43) Pub. Date: Dec. 29, 2022

(54) PET CHASE TOY

(71) Applicant: Hartdesign! Ltd., Chicago, IL (US)

(72) Inventor: Mark Hartelius, Chicago, IL (US)

(21) Appl. No.: 17/531,909

(22) Filed: Nov. 22, 2021

Related U.S. Application Data
(60) Provisional application No. 63/214,410, filed on Jun. 24, 2021.

(51) Int. Cl. A01K 15/02; B25J 5/00; G05B 19/4155

(52) U.S. Cl. CPC A01K 15/025; B25J 5/007; G05B 19/4155; G05B 2219/31264

(57) ABSTRACT

A pet toy includes a wheel base that moves randomly or pseudo-randomly and a rod detachably connected to the wheel base configured to hold a treat or other food item desirable to the pet companion is described herein. The wheel base and/or the rod may have one or more modes of movement that may be activated based on a movement algorithm that randomly or pseudo-randomly moves/turns the wheel base and/or the rod and/or a one or more sensors that detect obstacles. A proximate end of the may be detachably connected to a corresponding rod connector of the wheel base. The distal end of the rod may be configured to grab and/or hold the food item and/or have the food item wedged into it.

### RELATED APPLICATIONS

The application claims priority to U.S. Provisional Application No. 63/214,410 entitled, “CAT CHASE TOY,” filed Jun. 24, 2021, which is incorporated by reference in its entirety.

### TECHNICAL FIELD

The present disclosure generally relates pet toys and, more specifically, a toy to be chased by a pet.

### BACKGROUND

Keeping animal companions, such as cats, active and engage can improve the animal companion's quality of life. Some breeds, if not stimulated enough, will express antisocial behavior. Additionally, inactivity can adversely affect the health of the animal companion. Toys that satisfy an animal companion's instinct to hunt can help keep the animal companion engaged while maintaining the animal companion's interest over time. Frequently, owners operate toys to satisfy these needs. However, automated or electronic toys can be useful when circumstances do not allow the owner to directly play with the animal companion.

### SUMMARY

Cats, for example, can be food motivated. That is, cats can be motivated to engage in an activity and/or a behavior when food is used as a reward. As described here, a pet toy includes a wheel base that moves randomly or pseudo-randomly and a rod detachably connected to the wheel base configured to hold a treat or other food item desirable to the pet companion. The wheel base and/or the rod may have one or more modes of movement that may be activated based on a movement algorithm that randomly or pseudo-randomly moves/turns the wheel base and/or the rod and/or a one or more sensors that detect obstacles. A proximate end of the may be detachably connected to a corresponding rod connector of the wheel base. The distal end of the rod may be configured to grab and/or hold the food item and/or have the food item wedged into it. The wheel based may randomly or randomly or pseudo-randomly move the rod connector independently of the movement of the wheel base in two or more degrees of freedom.

These and other features and advantages of the present disclosure are set forth in the following specification, drawings and claims.

### BRIEF DESCRIPTION

Operation of the disclosure may be better understood by reference to the following detailed description taken in connection with the following illustrations, wherein:

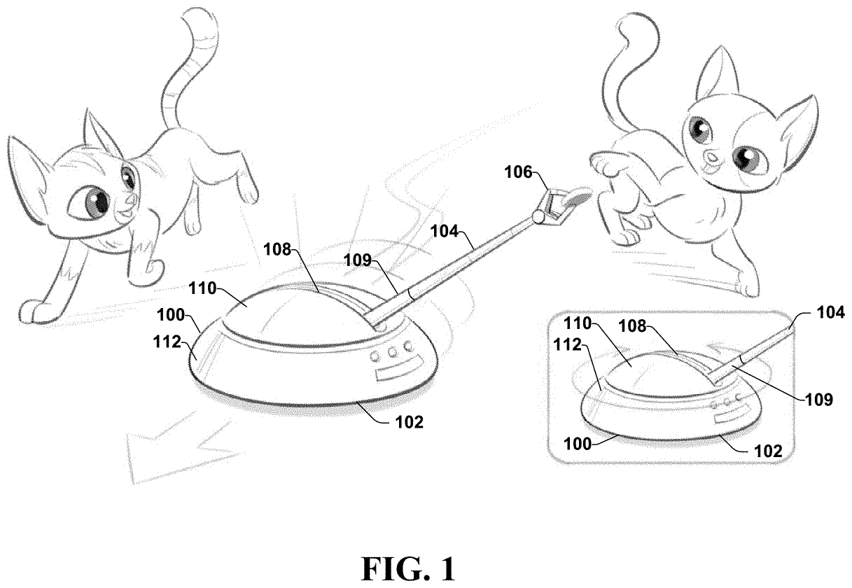

FIG. 1 illustrates an example of a pet chase toy, according to the teachings of this disclosure.

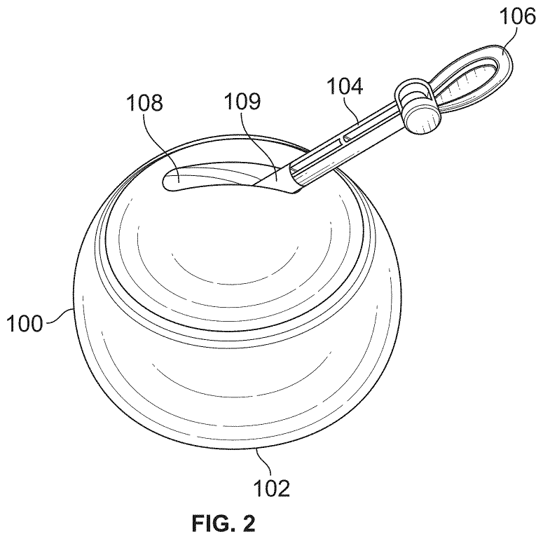

FIG. 2 illustrates an examples of a pet chase toy, according to the teachings of this disclosure.

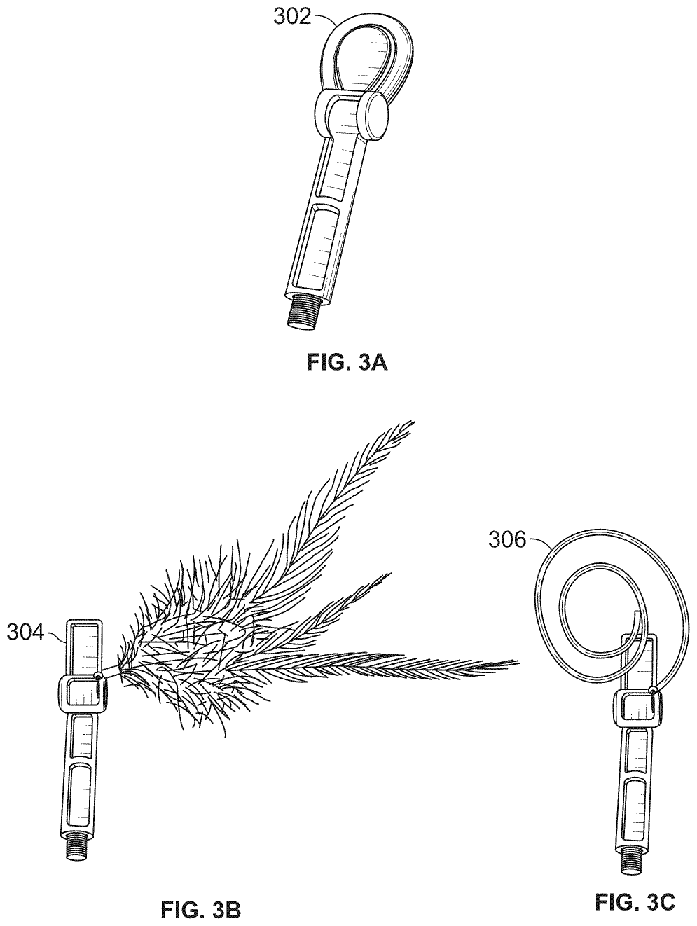

FIGS. 3A, 3B, and 3C illustrate example rods that may detachably connected to a wheel base on the pet chase toy, according to the teachings of this disclosure.

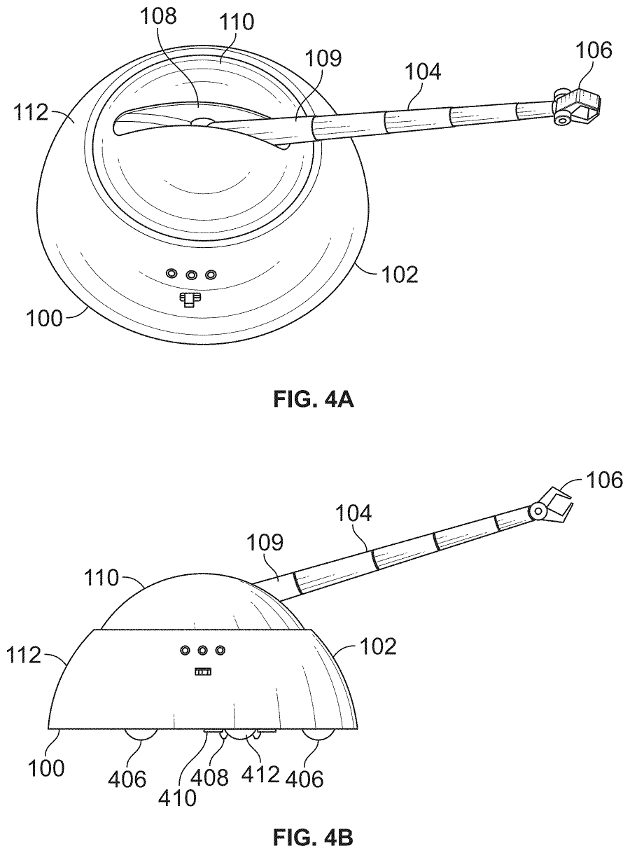

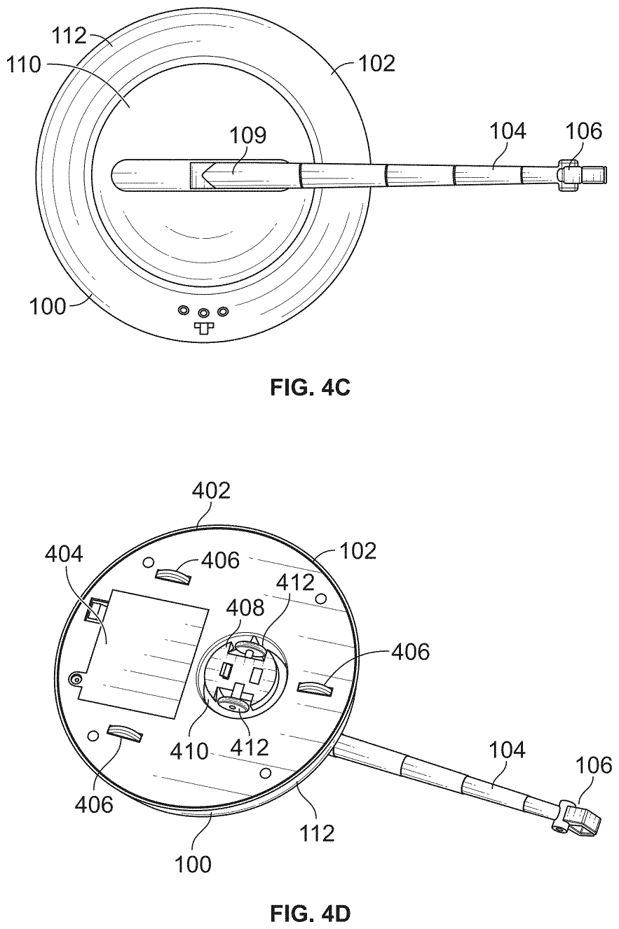

FIGS. 4A, 4B, 4C, and 4D illustrate various external views of the example pet chase toy, according to the teachings of this disclosure.

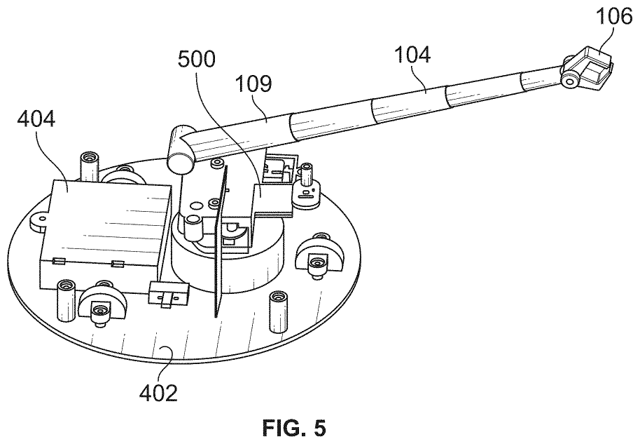

FIG. 5 illustrates a base of the example pet chase toy, according to the teachings of this disclosure.

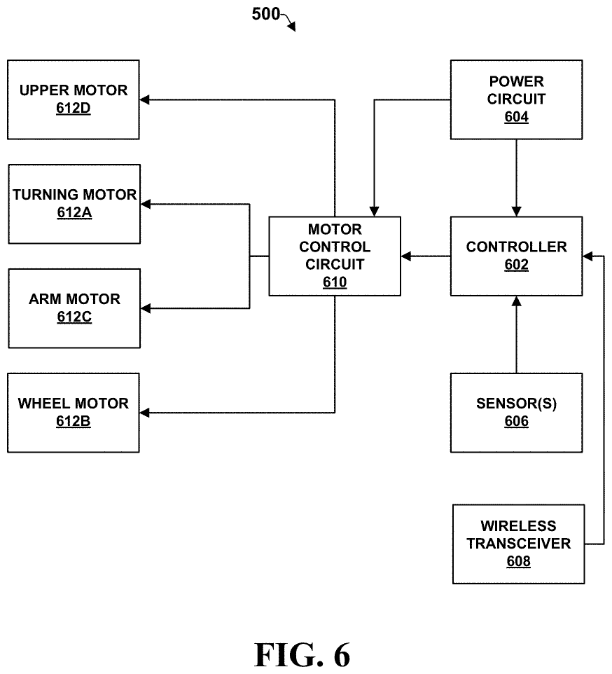

FIG. 6 is a block diagram of example control components of the example pet chase toy, according to the teachings of this disclosure.

### DESCRIPTION

Reference will now be made in detail to exemplary embodiments of the present disclosure, examples of which are illustrated in the accompanying drawings. It is to be understood that other embodiments may be utilized and structural and functional changes may be made without departing from the respective scope of the present disclosure. Moreover, features of the various embodiments may be combined or altered without departing from the scope of the present disclosure. As such, the following description is presented by way of illustration only and should not limit in any way the various alternatives and modifications that may be made to the illustrated embodiments and still be within the spirit and scope of the present disclosure.

FIGS. 1 and 2 illustrate example cat chase toys 100 to promote activity and engagement in cats. In the illustrated examples, the cat chase toy 100 is an electronic toy with treat holder on the end of an arm. The cat chase toy 100 randomly or pseudo-randomly moves and/or moves with external input (such as with obstacle detection via bump sensor, an infrared sensor, etc.). In the illustrated example, the cat chase toy 100 may comprise a body 102 and an arm 104. To motivate the cats, the cat chase toy 100 may comprise the arm 104 with a head 106 on its distal end configured to grab and/or otherwise hold a food item (sometimes referred to as a “treat”). The head 106, for example, may be configured to grab the treat (e.g., as illustrated in FIG. 1), such as through a spring loaded armature, a clamping device, or the like. In other examples, the head 106 may be configured to hold the treat (e.g., as illustrated in FIG. 2), such as through a friction fit, or the like. Any holding device may be utilized that is configured to hold the treat in an operative position in such a way that a cat can retrieve the treat. The holding device should provide enough pressure and/or grip that the treat remains relatively stationary during operation of the cat chase toy 100, but not too much that the cat can't remove the treat from the holding device. In some examples, the arm 104 may be interchangeable with other arms that are configured to entice cats in other ways.

FIGS. 3A, 3B, and 3C illustrate examples of interchangeable arms 104 with different heads 302, 304, and 306. The heads 302, 304, and 306 may be examples of the head 106 of FIGS. 1 and 2. For example, the different heads may include the friction hold heads 302 and 306 and a clamp head 304. While the friction hold heads 302 and 306 and a clamp head 304 are shown, the present disclosure isn't limited to these embodiments. In other examples, the head of the interchangeable arms 104 may comprise any kind of cat toy, e.g., a mouse, a ball, yarn, string, ribbon or the like and any combination of the foregoing. That is, the heads 302, 304, and 306 may include other elements to engage the attention of the cat along with the treat.

In some examples, a proximal end of the arm 104, opposite the head 106, may be configured to with a thread to screw into a corresponding treaded receptacle in the body 102. Alternatively, the proximal end of the arm 104 may comprise a mechanical attachment mechanism of any appropriate configuration, including, by way of a non-limiting example, a bayonet style attachment, a friction fit, a ball-bearing locking and release mechanism, a slot and tang, a pin and slot, a removable fastener or any other appropriate configuration of an attachment mechanism. In still yet other embodiments, the interchangeable arm 104 may be configured with the treat head 106 such that it can be used independent of or with the cat chase toy 100. The interchangeable arm 104 may be configured so that a user may grasp it and play with the cat or pet by including a treat on the treat head 106 as described in more detail herein.

In some examples, the treat head 106 is a spring loaded claw or armature that is configured to hold the treat between a pair of jaws (e.g., as illustrated in FIG. 1 and as head 304 of FIG. 3B). In some example, the force exerted by the claw is configured to hold the treat while the arm 104 is moving, and allow the cat to pull the treat form the treat head 106. In some examples, the treat head 106 includes an outer loop and an inner flange (e.g., as illustrated by head 302 in FIG. 3A). The outer loop and the inner flange define a space between them configured to accept a treat and, via friction, hold the treat in the treat head 106. In some examples, the treat head 106 may include a concentrically wound wire to hold the treat between the loops of the wires (e.g., as illustrated by head 305 of FIG. 3C).

While the interchangeable arm 104 illustrated in FIGS. 2, 3A, 3B, and 3C are relatively short, the interchangeable arm 104 may be relatively long (e.g., as illustrated in FIGS. 1, 4A, 4B, 4C, and 4D). This may allow the interchange arm 104 with the treat head 106 to be utilized with the cat chase toy 100 as described herein or as a separate play device where a user can play with a cat by luring it with the treat being engaged with the treat head 106. In this embodiment, the interchangeable arm 104 may comprise an elongated arm that comprises a treat head 106 attached thereto. The treat head 106 may be monolithically formed with the elongated arm or may be attached through fastening, adhering, friction fit, bayonet fit, threading or the like. The treat head 106 may be permanently fixed with the elongated arm or may be selectively attachable. The treat head 106 being selectively attachable may permit treat heads of different configurations to be selectively attached thereto.

In the illustrated example, that body 102 has a substantially semi-spherical shell. In some examples, the body 102 may have a dome shaped shell (e.g., an elliptical dome, an ellipsoidal dome, etc.) or a frustoconical shell. Alternatively, in some examples, the body 102 may have a cylinder or semi-cylinder shell. The body 102 includes motive components to control and cause the cat chase toy 100 to move. By erratically moving, the cat chase toy 100 may motivate cats to chase and engage with the cat chase toy 100. The motive components may include, for example, wheels, gearing, motors, sensors, and/or processing circuitry configured to move the body 102 and/or the arm 104. The motive components cause the cat chase toy 100 to move. In some examples, the motive components cause the cat chase toy 100 to move randomly or pseudo-randomly by moving forward and, from time-to-time, rotating a random or pseudo-random direction and moving forward again. Alternatively or additionally, in some examples, the motive components may include one or more sensors (e.g., a bump switch, an infrared sensor, accelerometers, gyroscopes, etc.) that detects objects to cause the cat chase toy 100 to switch directions upon detection of an object in front of it and/or determines a location of the cat chase toy 100 relative its surroundings.

In the illustrated example, the body 102 defines an armature slot 108 in which the arm 104 connects (e.g., detachably, etc.) to an arm mover 109 that causes the arm 104 to move within the armature slot 108. In some examples, the arm mover 109 that causes the arm 104 to move randomly or pseudo-randomly within the armature slot 108 as the cat chase toy 100 moves. In some examples, the arm mover 109 that causes the arm 104 to move rhythmically or periodically tied to the movement of the cat chase toy 100. In some examples, the body 102 may include an upper body 110 and a lower body 112. In some such examples, the upper body 110 may rotate about an axis defined by the body 102 on the lower body 112. In such examples, the rotation of the upper body 110 may add another degree of freedom to the movement of the arm 104 as the arm mover causes the arm 104 to move within the armature slot 108 and the upper body 110 rotates. In some examples, the rotation of the upper body 110 may be independent from the movement of the arm 104.

FIGS. 4A, 4B, 4C, and 4D illustrate various views of an example of the cat chase toy 100. In the illustrated example, the cat chase toy 100 includes the body 102 defining the armature slot 108 and the arm 104. As best illustrated in FIG. 4D, the body 102 includes a base 402. FIG. 5 illustrates an example of the base 402. The base 402 of the body 102 includes a battery compartment 404 to receive batteries to power motive components 500 (e.g., as illustrated in FIG. 6 below). The base 402 also includes passive wheels 406 and a drive assembly 408 that provides the motive force to the cat chase toy 100. The drive assembly 408 includes a mounting plate 410 and active wheels 412. The mounting plate 410 is connected to the motive components 500 such that it is turnable or rotatable to steer the active wheels 412. The active wheels 412 may be coupled to the motive components 500 which drive the active wheels 412 to move the cat chase toy 100.

In the alternative, the motive components 500 may comprise a wind-up device whereby a user moves the cat chase toy 100 in a reverse direction. This “winds up” the motive components 500. The user may then release the cat chase toy 100 and the motive components 500 will drive the cat chase toy 100 in a random or pseudo-random direction. The wind-up mechanism may use energy conservation and conversion to drive the cat chase toy 100. The wind up mechanism may comprise a spiral spring that may be attached to a winder and a gear. When the user rotates the winder with force, the energy is stored in the wound up spring as potential energy. Upon release, the potential energy is released into energy driving the cat chase toy 100. The foregoing wind up mechanism is exemplary. Any appropriate wind up mechanism may be utilized without departing from the present teachings.

In addition or in the alternative, a remote control, such as a radio frequency device or near field communication device may be utilized to drive the motive components 500. In some embodiments a separate control device may be utilized to drive and/or alter the motive components. In other embodiments, the cat chase toy 100 may include a near field communication device or Bluetooth device that is able to communicate with a smart device such as a smartphone, tablet or separate computing device. In these embodiments, the smartphone, tablet or separate computing device may be in operative communication with the cat chase toy 100 or more specifically the motive components 500 to drive or alter the operating parameters thereof.

In yet some embodiments, a user may utilize his/her smartphone, tablet, separate computing device or dedicated control device to operate the cat chase toy 100. In these embodiments, the user may send instruction to the cat chase toy 100 to drive to a location. At the location, the user may send instructions for the cat chase toy 100 to pick up a treat using its arm 104 and the treat head 106 or any other holding device. The user then may operate the cat chase toy 100 as described above.

FIG. 6 is a block diagram of example motive components 500. In the illustrated example, the motive components include a controller 602, a power circuit 604, one or more sensors 606, a wireless transceiver 608, a motor control circuit 610, and motors 612A, 612B, 612C, and 612D. A configuration of the cat chase toy 100 may have more or fewer of these example components depending on the functionality of the cat chase toy 100.

The controller 602 controls the motion of the cat chase toy 100 by controlling, via the motor control circuit 610, the motors 612A, 612B, 612C, and/or 612D. The controller 602 may move the cat chase toy 100 (i) randomly or pseudo-randomly according to a program instantiated in the hardware and/or software of the controller 602, (ii) based on input from the sensor(s) 606, and/or (iii) in response to command received via the wireless transceiver 608. The controller 602 may be any suitable processing device or set of processing devices such as, but not limited to: a microprocessor, a microcontroller-based platform, a suitable integrated circuit, one or more field programmable gate arrays (FPGAs), and/or one or more application-specific integrated circuits (ASICs). In some examples, the controller 602 may include memory to, for example store instructions and/or algorithms to control the cat chase toy 100.

The power circuit 604 regulates power from the batteries to be suitable to power the one or more sensors 606, a wireless transceiver 608, a motor control circuit 610, and motors 612A, 612B, 612C, and 612D. The sensor(s) 606 may include bump sensors, infrared sensors, accelerometers, gyroscopes, and/or inertial measurement units to provide information about the area surrounding the cat chase toy 100. The sensor(s) 606 may, for example, facilitate control of the cat chase toy 100 by the controller 602 in an environment-aware manner.

The wireless transceiver 608 may be configured for Bluetooth® and/or other standards-based networks (e.g., Global System for Mobile Communications (GSM), Universal Mobile Telecommunications System (UMTS), Long Term Evolution (LTE), Code Division Multiple Access (CDMA), WiMAX (IEEE 802.16m); local area wireless network (including IEEE 802.11 a/b/g/n/ac or others), and Wireless Gigabit (IEEE 802.11ad), etc.) to facilitate remote control of the cat chase toy 100 via a computing device (e.g., a smartphone, a smart watch, a tablet, a browser running on a desktop or laptop computer, etc.) such that the cat chase toy 100 may be controlled by a user in the vicinity of the cat chase toy 100 or remote from the cat chase toy 100 (e.g., via the internet).

The motor control circuit 610 is configured to control the motors 612A, 612B, 612C, and 612D. The motor control circuit 610 may include, for example, circuitry to control starting and stopping the motors 612A, 612B, 612C, and 612D, circuitry to select rotation direction of the motors 612A, 612B, 612C, and 612D, and/or circuitry to regulate the speed of the motors 612A, 612B, 612C, and 612D, etc. The turning motor 612A may control a shaft to turn the active wheels 412 to control the direction that the cat chase toy 100 is moving. The wheel motor 612B may control the active wheels 412 to cause the cat chase toy 100 to move. The arm motor 612C may control the movement of the arm mover 109 to cause the arm 104 to move within the armature slot 108. The upper motor 612D may control rotation of the upper body 110. The motors 612A, 612B, 612C, and 612D may be DC motors or stepper motors, etc.

Although the embodiments of this disclosure have been illustrated in the accompanying drawings and described in the foregoing detailed description, it is to be understood that the present disclosure is not to be limited to just the described embodiments, but that the embodiments described herein are capable of numerous rearrangements, modifications and substitutions without departing from the scope of the claims hereafter. It is, of course, not possible to describe every conceivable combination of components or methodologies for purposes of describing the present specification, but one of ordinary skill in the art may recognize that many further combinations and permutations of the present specification are possible. Each of the components described above may be combined or added together in any permutation to define an introducing device and/or introducing system. Accordingly, the present specification is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim. The claims as follows are intended to include all modifications and alterations insofar as they come within the scope of the claims or the equivalent thereof.

1. An electronic pet toy comprising:
a body configured to autonomously move about a space; and
an arm, a proximal end of the arm attached to the body and distal end of the arm configured to hold a treat to entice a pet to engage with the electronic pet toy.

2. The electronic pet toy of claim 1, wherein the arm includes a detachment point between the proximal end and the distal end where the distal end can be detached from the arm.

3. The electronic pet toy of claim 1, wherein the body includes an upper portion and a lower portion, and wherein the upper portion rotates upon an axis relative the lower portion.

4. The electronic pet toy of claim 1, wherein the body includes a slot through which the arm extends.

5. The electronic pet toy of claim 5, wherein the arm is configured to move within the slot.

6. The electronic pet toy of claim 1, wherein distal end of the arm configured to hold the treat includes a spring loaded claw.

7. The electronic pet toy of claim 1, wherein distal end of the arm configured to hold the treat includes a loop and an inner flange defining a space therebetween configured to accept the treat.

8. The electronic pet toy of claim 1, wherein distal end of the arm configured to hold the treat includes a concentrically looped wire defining a space therebetween configured to accept the treat.

9. A pet toy comprising:
an elongated arm configured to be secured to a body of an electronic pet toy; and
a treat head attached with the elongated arm, wherein the treat head is configured to hold a cat treat.

10. The pet toy of claim 9, wherein the treat head is detachable from the elongated arm.

11. The pet toy of claim 9, wherein the treat head includes a spring loaded claw.

12. The pet toy of claim 9, wherein the treat head includes a loop and an inner flange defining a space therebetween configured to accept the treat.

13. The pet toy of claim 9, wherein the treat head includes a concentrically looped wire defining a space therebetween configured to accept the treat.

14. The pet toy of claim 9, wherein the elongated arm is secured to the body with a slot define by the body.

15. A pet toy comprising:
a dome-shaped body having an upper portion and a lower portion;
a plurality of motors within the dome-shaped body;
control circuitry electrically coupled to the motors;
an elongated arm configured to be secured to a body of an electronic pet toy; and
a treat head attached with the elongated arm, wherein the treat head comprises an outer loop and an inner flange defining a space therebetween configured to accept a treat.

16. The pet toy of claim 15, wherein the outer loop and the inner flange are configured to hold a treat via friction.

17. The pet toy of claim 15, wherein the elongated arm extends through a slot defined in the upper portion of the dome-shaped body.

18. The pet toy of claim 17, wherein the elongated arm is coupled to one of the plurality of motors, and wherein the motor causes the arm to move in an arc defined by the slot.

19. The pet toy of claim 15, wherein at least one of the plurality of motors is configured to cause wheels to move the pet toy, and wherein the control circuitry causes the motor to move the pet toy randomly or pseudo-randomly.

20. The pet toy of claim 15, including a wireless controller to wirelessly communicate with a computing device to influence movement of the pet toy.

21. The pet toy of claim 15, wherein the upper portion of the dome-shaped body and the elongated arm move about an axis relative the lower portion of the domed-shaped body.
